(19) United States
(12) Patent Application Publication
(10) Pub. No.: US 2009/0233196 A1
(43) Pub. Date: Sep. 17, 2009

(54) Photoconductors Containing Copper Phthalocyanine and Titanyl Phthalocyanine in the Charge Generation Layer

(76) Inventors: Mark Thomas Bellino, Loveland, CO (US); Weimei Luo, Louisville, CO (US); Scott Daniel Reeves, Louisville, CO (US); Tanya Yvonne Thames, Aurora, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/029,863

(22) Filed: Mar. 14, 2008

(51) Int. Cl. G03C 1/73; G03C 1/74

(52) U.S. Cl. 430/58.8; 430/133

(57) ABSTRACT

Embodiments of a photoconductor comprise an electrically conductive substrate, a charge generation layer disposed over the electrically conductive substrate, wherein the charge generation layer comprises titanyl phthalocyanine and copper phthalocyanine, and a charge transport layer disposed over the charge generation layer.

### STATEMENT REGARDING FEDERALLY SPONSORED RESEARCH OR DEVELOPMENT

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

Embodiments of the this invention are generally directed to photoconductors and are specifically directed to photoconductors comprising charge generation layers having mixtures of copper phthalocyanine (CuPC) and titanyl phthalocyanine (TiOPC).

2. Description of the Related Art

In electrophotography, a latent image is created on the surface of an imaging member such as a photoconducting material by first uniformly charging the surface and then selectively exposing areas of the surface to light. A difference in electrostatic charge density is created between those areas on the surface which are exposed to light and those areas on the surface which are not exposed to light. The latent electrostatic image is developed into a visible image by electrostatic toners. The toners are selectively attracted to either the exposed or unexposed portions of the photoconductor surface, depending on the relative electrostatic charges on the photoconductor surface, the development electrode and the toner. Electrophotographic photoconductors may be a single layer or a laminate formed from two or more layers (multi-layer type and configuration).

Typically, a dual layer electrophotographic photoconductor comprises a substrate such as a metal ground plane member on which a charge generation layer (CGL) and a charge transport layer (CTL) are coated. The charge transport layer contains a charge transport material which comprises a hole transport material or an electron transport material.

When the charge transport layer containing a hole transport material is formed on the charge generation layer, a negative charge is typically placed on the photoconductor surface. Conversely, when the charge generation layer is formed on the charge transport layer, a positive charge is typically placed on the photoconductor surface. Conventionally, the charge generation layer comprises the charge generation compound or molecule alone and/or in combination with a binder. A charge transport layer typically comprises a polymeric binder and a charge transport compound or molecule. The charge generation compounds within the charge generation layer are sensitive to image-forming radiation and photogenerate electron hole pairs therein as a result of absorbing such radiation. The charge transport layer is usually non-absorbent of the image-forming radiation and the charge transport compounds serve to transport holes to the surface of a negatively charged photoconductor.

Charge generation layers are generally prepared by dispersing a pigment (e.g., phthalocyanines, azo compounds, squaraines, etc.) and pigment mix in polymeric matrix. Since the pigment or dye in the charge generation layer typically does not have the capability of binding or adhering effectively to a metal substrate, the polymer binder is usually inert to the electrophotographic process, but forms a stable dispersion with the pigment/dye and has good adhesive properties to the metal substrate. The electrical sensitivity associated with the charge generation layer can be affected by the nature of polymeric binder used. The polymeric binder, while forming a good dispersion with the pigment should also adhere to the metal substrate.

In one conventional charge generation layer, titanyl phthalocyanine (IV) is utilized to produce a highly sensitive photoconductor. However, some situations require a less sensitive photoconductor without impacting the residual discharge voltage of a resulting photoconductor, thereby enabling superior gray scale, which has become increasingly important in high-end color printer design. In other words, it is desirable to design a photoconductor with gradual slope and low residual discharge voltage in the photo-induced-discharge (PID) curve to meet these special needs under certain printing parameters. One common method used to produce a photoconductor with the described characteristics of PID utilizes a mix of titanyl phthalocyanine type I and type IV in the charge generation layer; however, a lengthy milling process including a pre-grinding step is required.

Accordingly, there is a need for improved photoconductor compositions that are operable to produce superior gray scale sensitivity, and improved methods for producing these improved photoconductors.

### SUMMARY OF THE INVENTION

In accordance with one embodiment, a photoconductor is provided. The photoconductor comprises an electrically conductive substrate, a charge generation layer disposed over the electrically conductive substrate, wherein the charge generation layer comprises titanyl phthalocyanine and copper phthalocyanine, and a charge transport layer disposed over the charge generation layer.

In accordance with another embodiment, a method of preparing a photoconductor is provided. The method comprises the steps of providing an electrically conductive substrate, dispersing titanyl phthalocyanine and copper phthalocyanine in a binder without first grinding the titanyl phthalocyanine, milling the dispersed titanyl phthalocyanine and copper phthalocyanine inside the binder to produce a charge generation layer over the electrically conductive substrate, and coating the charge generation layer with a charge transport layer to form the photoconductor.

These and additional objects and advantages provided by the embodiments of the present invention will be more fully understood in view of the following detailed description, in conjunction with the drawings.

### BRIEF DESCRIPTION OF THE DRAWINGS

The following detailed description of specific embodiments of the present invention can be best understood when read in conjunction with the drawings enclosed herewith wherein:

FIG. 1 is a schematic cross sectional view of a photoconductor according to one or more embodiments of the present invention; and

FIG. 2 is a schematic illustrating a photoconductor in conjunction with a developing unit, cleaning unit, charging roller, etc according to one or more embodiments of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION

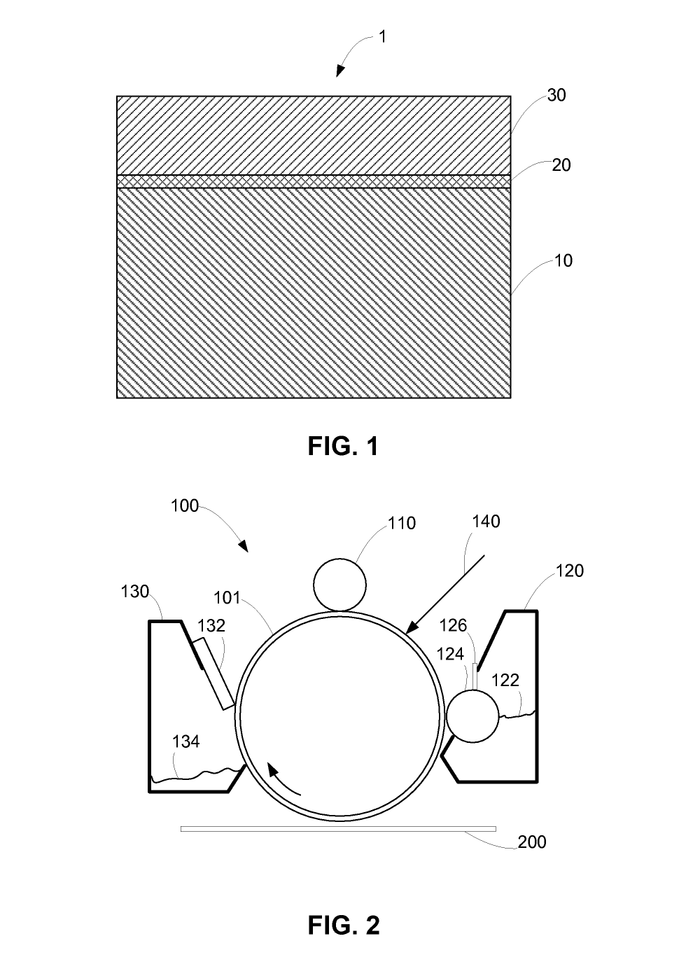

Embodiments of the present invention are directed to photoconductors and methods of making photoconductors. Referring to FIG. 1, the photoconductor 1 comprises an electrically conductive substrate 10, and a charge generation layer 20 disposed over the electrically conductive substrate 10. As used herein, “over” may mean one layer is directly on another layer, or may also allow for intervening layers therebetween. The charge generation layer 20 comprises a mixture of titanyl phthalocyanine (TiOPC) and copper phthalocyanine (CuPC). Further as shown, the photoconductor 1 comprises a charge transport layer 30 disposed over the charge generation layer 20. As shown in FIG. 2, the photoconductor 1 is in the form of a drum; however, other embodiments are contemplated herein.

Referring to FIG. 1, the electrically conductive substrate 10 comprises an electrically conductive metal based material. The substrate 10 may be flexible, for example in the form of a flexible web or a belt, or inflexible, for example in the form of a drum. Typically, the photoconductor substrate is uniformly coated with a thin layer of metal, preferably aluminum which functions as an electrical ground plane. In one embodiment, the electrically conductive substrate 10 comprises an anodized and sealed aluminum core. Alternatively, the ground plane member may comprise a metallic plate formed, for example, from aluminum or nickel, a metal drum or foil, or plastic film on which aluminum, tin oxide, indium oxide or the like is vacuum evaporated. Typically, the substrate 10 will have a thickness adequate to provide the required mechanical stability. For example, flexible web substrates generally have a thickness of from about 0.01 to about 0.1 microns, while drum substrates generally have a thickness of from about 0.75 mm to about 1.0 mm.

The charge generation layer 20 comprises a mixture of titanyl phthalocyanine (TiOPC) and copper phthalocyanine (CuPC) as its charge generation material. The mixture of titanyl phthalocyanine and copper phthalocyanine may be in the form of a pigment dispersed inside a binder. The titanyl phthalocyanine may comprise titanyl phthalocyanine (I), titanyl phthalocyanine (IV), or combinations thereof. In the examples provided below, the charge generation layer comprises mixtures of CuPC and TiOPC (type IV). Type I and Type IV are different yet operable crystal structures of TiOPC, Type IV demonstrates increased photoconductor sensitivity. Typically purity, crystal structure, morphology and dispersion preparation conditions all influence the photoconductor sensitivity. The binder of the charge generation layer may comprise various compositions familiar to one of ordinary skill in the art (e.g., polyvinyl butyral, epoxy resin, and combinations thereof). The epoxy resin may be EPON 1001®, a derivative of bisphenol A and epichlorohydrin produced by Hexion Specialty Chemicals. One suitable polyvinyl butyral composition is BX-1 produced by Sekisui Chemical Co. The charge generation layer may also comprise various resins or organic solvents, for example, poly(methyl-phenyl)siloxane, polyhydroxystyrene, phenolic novolac, 2-butanone, and cyclohexanone. Referring to the embodiment of FIG. 1, the charge generation layer may comprise a thickness of about 0.1 to about 1.0 μm, or preferably about 0.2 to about 0.3 μm. Moreover, the charge generation layer may comprise a mean particle size between about 110 to about 130 nm.

The charge generation layers of present invention are highly stable. This is highlighted in Tables 5 and 6, which compares fresh dispersions versus a 10 week old dispersions.

As shown in the examples below, the photoconductors incorporating these charge generation layers provide desirable photo-induced-discharge characteristics and high fatigue resistance upon cycling in printer. Furthermore, the photoconductors of the current invention show reduced residual image and ghosting compared to pure TiOPC charge generators (see Table 1).

Moreover, the mixture of CuPC to TiOPC (IV) provides improved control of charge sensitivity, which is important for enabling superior gray scale during printing. The range of charge generation sensitivities may be modified by altering the ratios of CuPC to TiOPC (IV). For example, the ratio by weight of titanyl phthalocyanine to copper phthalocyanine may be varied from about 50/50 to about 99/1, or about 90/10 to about 99/1. In yet another exemplary embodiment, the ratio by weight of copper phthalocyanine and titanyl phthalocyanine to binder is about 3 to 2.

The charge transport layer is comprised of one or more charge transport molecules and binder, with and without additives. In one embodiment, the charge transport layer may comprise an aromatic amine and a polycarbonate in an organic solvent. An aromatic amine such as N,N′-Bis(3-methylphenyl)-N,N′-diphenylbenzidine (TPD) is a highly effective charge transport molecule.

Other charge transport molecules, in addition to TPD, are contemplated herein. For example, and not by way of limitation, the charge transport molecules may comprises pyrazoline, fluorene derivatives, oxadiazole transport molecules such as 2,5-bis(4-diethylaminophenyl)-1,3,4-oxadiazole, imidazole, and triazole, hydrazone transport molecules including p-diethylaminobenzaldehyde-(diphenylhydrazone), p-diphenylaminobenzaldehyde-(diphenylhydrazone), o-ethoxy-p-diethylaminobenzaldehyde-(diphenylhydrazone), o-methyl-p-diethylaminobenzaldehyde-(diphenylhydrazone), o-methyl-p-dimethylaminobenzaldehyde(diphenylhydrazone), p-dipropylaminobenzaldehyde-(diphenylhydrazone), p-diethylaminobenzaldehyde-(benzylphenylhydrazone), p-dibutylaminobenzaldehyde-(diphenylhydrazone), p-dimethylaminobenzaldehyde-(diphenylhydrazone). Other suitable hydrazone transport molecules include compounds such as 1-naphthalenecarbaldehyde1-methyl-1-phenylhydrazone, 1-naphthalenecarbaldehyde1,1-phenylhydrazone, 4-methoxynaphthlene-1-carbaldehyde1-methyl-1-phenylhydrazone, carbazole phenyl hydrazones such as 9-methylcarbazole-3-carbaldehyde-1,1-diphenylhydrazone, 9-ethylcarbazole-3-carbaldehyde-1-methyl-1-phenylhydrazone, 9-ethylcarbazole-3-carbaldehyde-1-ethyl-1-phenylhydrazone, 9-ethylcarbazole-3-carbaldehyde-1-ethyl-1-benzyl-1-phenylhydrazone, 9-ethylcarbazole-3-carbaldehyde-1,1-diphenylhydrazone, derivatives of aminobenzaldehydes, cinnamic esters or hydroxylated benzaldehydes. Diamine and triarylamine transport molecules such as N,N-diphenyl-N,N-bis(alkylphenyl)-[1,1′-biphenyl]-4,4′-diamines wherein the alkyl is, for example, methyl, ethyl, propyl, n-butyl, or the like, or halogen substituted derivatives thereof, commonly referred to as benzidine and substituted benzidine compounds, and the like are also contemplated herein. Typical triarylamines include, for example, tritolylamine, and the like.

The organic solvent of the charge transport layer may comprise tetrahydrofuran, 1,4-dioxane, or mixtures thereof. Other solvents are contemplated herein. Referring again to the embodiment of FIG. 1, the charge transport layer may comprise a thickness of about 20 to about 30 μm.

To form the photoconductor, the titanyl phthalocyanine and copper phthalocyanine are dispersed in a binder, and then the dispersed titanyl phthalocyanine and copper phthalocyanine inside the binder is milled to produce a charge generation layer dispersion. Using a CuPC and TiOPC blend (e.g. TiOPC type IV) simplifies the process of producing the charge generation layer. Unlike conventional charge generation layers which utilize mixtures of titanyl phthalocyanine (I) and (IV), the blend of CuPC and TiOPC does not require a grinding step prior to milling. The pregrind may be required for TiOPC type I because this polymorph is harder and requires a longer milling time than TiOPC type IV to reach the desired particle size (for example, an additional 4-10 hours of milling time). However, CuPC does not require the pregrind step to reach the optimum particle size. If type IV is milled this long, an amorphous form of TiOPC may result which does not have the desired photoconductor sensitivity. After the charge generation layer 20 is coated on the electrically conductive substrate 10, the charge transport layer 30 is coated on the charge generation layer 20 to form the photoconductor 1. After the charge transport layer is applied, it may be cured at a temperature of about 110° C. for about 1 hour. By eliminating the grinding step, the present methods provide an efficient and reproducible way to produce charge generation dispersions for use in a laminate photoconductor.

The photoconductor of the present invention may be utilized in various printer configurations familiar to one of ordinary skill in the art. On such configuration is illustrated in FIG. 2. The image forming apparatus 100 (e.g., a printer) may comprise a photoconductor 101, a charging roller 110, a developer unit 120 and a cleaner unit 130. The charging roller 110 negatively charges the surface of the photoconductor 101. The charged surface of the photoconductor may then be irradiated by a laser light source 140 to form an electrostatic latent image on the photoconductor 101 corresponding to an image. The developing unit 120 may include a toner sump 122, a developer roller 124 and a toner metering device 126. Toner in the sump is transferred to the surface of developer roll 124 by various means including a toner transfer roller (not shown). The toner metering device 126 such as a doctor blade serves as a means of providing a uniform layer of toner on the developer roller 124. The developer roller 124 and doctor blade 126 can be charged which in turn charges the toner. The charged toner is attached to the latent image on the photoconductor 101. The image from the photoconductor 101 may be transferred directly to a recording medium, (e.g., paper 200) or may utilize an intermediate transfer belt (not shown) to transfer the image to the paper 200. A fusing unit (not shown) is used to fuse the toner image to the paper 200. A cleaning unit 130 uses a cleaning blade 132 to scrape off any residual toner still adhering to the photoconductor 101 after the image is transferred to the paper 200. The cleaned surface of the photoconductor can now be charged again, repeating the imaging and printing cycle. The waste toner 134 is held in a waste toner sump in the cleaning unit 130.

### EXAMPLES

To demonstrate the improved properties of the photoconductors comprising charge generation layers with CuPC/TiOPC, the following experimental examples are provided. The following examples contain a comparative photoconductor example comprises only TiOPC in the charge generation layer, and several photoconductor embodiments comprising TiOPC and CuPC in the charge generation layer. All examples are evaluated using the test method and algorithm described below.

The photo-electrostatic properties of a photoconductor are evaluated with an off-line tester. The architecture of the electrostatic tester is similar to a printer base system. The main components include a charge roll, a high speed electrostatic probe, an erase lamp, and a low-power laser. To ensure correct operation, each of these components is oriented at specified locations and distances. The tester and the test sequence is software controlled. Below is a brief description of the test algorithm:

Negative AC or DC charge is applied to the charge roll shaft. The charge roll and the photoconductor are in contact and are rotating at a constant speed. The interface between the charge roll and photoconductor induces a negative charge voltage on the photoconductor. Charge voltage is specific to a product.

Once the desired charge level is reached on the photoconductor, the laser will turn on, effectively discharging the charge level at the specified location. The electrostatic probe will then measure this discharge level. This step can be construed as the expose to develop time. The rotational speed of the photoconductor usually remains constant. In order to emulate a particular printer speed, the distance between the laser and the electrostatic probe is adjusted. A short distance will emulate a fast printer whereas, a wider distance a slow printer.

Once the discharge voltage is recorded, the erase lamp will neutralize the remaining amount of voltage on the photoconductor.

Measurements are recorded at various laser powers.

### Comparative Example 1

The charge generation layer formulation consisted of a mix of phthalocyanine titanium oxide complex (TiOPC) with the ratio of type I to type IV of 1 to 2. BX-1 (PVB) and Epon (epoxy resin) in a 3/2 ratio was used as binder in the formulation. The weights of each component were as follows: 30.15 g of TiOPC (IV), 14.85 g of TiOPC (I), 22.09 g of PVB (BX-1), and 14.71 g of Epon 1001. A pre-grinding step of type I TiOPC in solvents for about 4 to 6 hours was followed by a regular milling process. The dispersion was prepared via a milling process to a final mean particle sizes between 160 to 180 nm.

The charge transport layer formulation was prepared by dissolving 31.5 g of N,N′-Bis(3-methylphenyl)-N,N′-diphenylbenzidine(TPD) and 58.5 g of polycarbonate Z-300 (Mitsubishi Gas Chemical Co., Inc.) in a mixed solvent of tetrahydrofuran and 1,4-dioxane. The charge transport layer was coated on top of the charge generation layer and cured at 110° C. for 1 hour to give a thickness of 24-26 μm.

### Example 1

The charge generation layer formulation consisted of a mix of titanium oxide phthalocyanine complex (TiOPC) and copper phthalocyanine complex (CuPC) in the ratio of 90/10. BX-1 and Epon in a 3/2 ratio was used as the binder in the formulation. The weights of each component were as follows: 40.50 g of TiOPC (IV), 4.50 g of CuPC, 22.09 g of PVB (BX-1), and 14.71 g of Epon 1001. The dispersion was prepared via a milling process to a final mean particle sizes between 160 to 180 nm. The charge transport layer was the same composition as that described in Comparative Example 1.

### Example 2

The charge generation layer formulation consisted of a mix of TiOPC and CuPC in the ratio of 91/9. BX-1 and Epon in a 3/2 ratio was used as the binder in the formulation. The weights of each component were as follows: 40.959 of TiOPC (IV), 4.05 g of CuPC, 22.09 g of PVB (BX-1), and 14.71 g of Epon 1001. The dispersion was prepared via a milling process to a final mean particle sizes between 160 to 180 nm. The charge transport layer was the same composition as that described in Comparative Example 1.

### Example 3

The charge generation layer formulation consisted of a mix of TiOPC and CuPC in the ratio of 94/6. BX-1 and Epon in a 3/2 ratio was used as the binder in the formulation. The weights of each component were as follows: 42.30 g of TiOPC (IV), 2.70 g of CuPC, 22.09 g of PVB (BX-1), and 14.71 g of Epon 1001. The dispersion was prepared via a milling process to a final mean particle sizes between 160 to 180 nm. The charge transport layer was the same composition as that described in Comparative Example 1.

### Example 4

The charge generation layer formulation consisted of a mix of TiOPC and CuPC in the ratio of 97/3. BX-1 and Epon in a 3/2 ratio was used as binder in the formulation. The weights of each component were as follows: 46.65 g of TiOPC (IV), 1.35 g of CuPC, 22.09 g of PVB (BX-1), and 14.71 g of Epon 1001. The dispersion was prepared via a milling process to a final mean particle sizes between 160 to 180 nm. The charge transport layer was the same composition as that described in Comparative Example 1.

The initial PID curves were taken on all examples. All of the photoconductor drums were charged to −750V. Expose-to-develop time was set at 105 ms. Table 1 summarizes the discharge voltages of the resulting photoconductors at various energy points and dark decay at 1 second. The data in Table 1 indicates that the charge generation dispersion in Example 1 provides very similar electrical properties to the Comparative Example 1 and lower discharge voltages result from less amount of CuPC in a dispersion.

TABLE 1
Off-line Photo-Induced Discharge (charge at −750 V and
expose-to-develop time at 105 ms)

| | Initial Electricals | | | |
|---|---|---|---|---|
| Drum | | | | Dark Decay |
| Description | V@0.18 μJ | V@0.33 μJ | V@1.00 μJ | 1 sec |
| Comparative | −249.7 | −88 | −44.3 | 21.9 |
| Example 1 | | | | |
| Example 1 | −226.1 | −90 | −55.6 | 32.5 |
| Example 2 | −178.78 | −81 | −55.0 | 16.3 |
| Example 3 | −188.1 | −77 | −48.7 | 12.0 |
| Example 4 | −154.4 | −65 | −46.9 | 13.4 |

The drums coated with charge generation dispersions illustrated in the examples described above and Comparative Example 1 were tested in Lexmark color laser printer C780. Toner usage including toner to page (TTP, in mg) and toner to cleaner (TTC, in mg) was recorded along with discharge voltages at start of test (SOT) and then end of test (EOT, 10,000 pages). Fatigue represents the discharge voltage shift between SOT and EOT. As shown in Tables 2 and 3, the CG layers consisting of CuPC/TiOPC perform very similarly as TiOPC type I and IV mix in terms of discharge of voltage and fatigue in the printer.

TABLE 2
Printer test 50 ppm with run mode of 2 pages and pause at lab ambient

| | | | | Discharge Voltage | | | | |
|---|---|---|---|---|---|---|---|---|
| Drum | | | | | 3K | 6K | 9K | |
| Description | Pages | TTP | TTC | SOT | pgs | pgs | pgs | Fatigue |
| Example 1 | 9084 | 10.7 | 13.8 | 288 | 278 | 279 | 274 | 14 |
| Example 1 | 9084 | 8.4 | 12.7 | 287 | 278 | 279 | 274 | 13 |
| Comparative | 9084 | 8.6 | 13.2 | 281 | 270 | 269 | 267 | 14 |
| Example 1 | | | | | | | | |
| Comparative | 9084 | 10.0 | 13.4 | 283 | 271 | 269 | 269 | 14 |
| Example 1 | | | | | | | | |

TABLE 3
Printer test 50 ppm with run mode of 2 pages and pause at 78° F.
and 80% humidity

| | | | | Discharge Voltage | | | | |
|---|---|---|---|---|---|---|---|---|
| Drum | | | | | 3K | 6K | 9K | |
| Description | Pages | TTP | TTC | SOT | pgs | pgs | pgs | Fatigue |
| Example 1 | 9084 | 11.5 | 14.1 | 288 | 283 | 275 | 270 | 18 |
| Example 1 | 9084 | 9.6 | 11.0 | 289 | 284 | 278 | 273 | 16 |
| Comparative | 9084 | 9.9 | 9.3 | 273 | 282 | 286 | 283 | −10 |
| Example 1 | | | | | | | | |
| Comparative | 9084 | 11.9 | 10.2 | 274 | 279 | 284 | 283 | −9 |
| Example 1 | | | | | | | | |

The drums coated with the charge generation dispersions illustrated in the examples described above and Comparative Example 1 were evaluated for photoconductor (PC) residual image in a Lexmark brand 25 ppm color laser printer. Table 4 measures the difference in L* for the region of a printed page at PC drum revolution frequency under a solid band versus under an imprinted area. The higher ΔL* value represents more severe PC residual image. The combination of copper phthalocyanine and titanyl phthalocyanine may effectively reduce PC residual image as illustrated in Table 4.

TABLE 4
PC Residual Image evaluated in 25 ppm color laser printer with
run mode of 2 pages and pause at lab ambient

| | ΔL* | Charge | Discharge |
|---|---|---|---|
| Drum Description | (PC Drum Frequency) | Voltage | Voltage |
| Example 1, Drum 1 | 1.0 | −811 | −158 |
| Example 1, Drum 2 | 1.1 | −814 | −159 |
| Example 1, Drum 3 | 1.2 | −812 | −151 |
| Example 1, Drum 4 | 0.4 | −807 | −129 |
| Comparative Example 1, | 2.0 | −816 | −135 |
| Drum 1 | | | |
| Comparative Example 1, | 2.2 | −816 | −135 |
| Drum 2 | | | |

The drums coated with charge generation dispersions illustrated in examples described above and Comparative Example 1 were tested in Lexmark color laser printer C780. Toner usage including toner to page (TTP, in mg) and toner to cleaner (TTC, in mg) was recorded along with discharge voltages at start of test (SOT) and then end of test (EOT, 10,000 pages). Fatigue represents the discharge voltage shift between SOT and EOT. The data in Table 5 shows that the dispersion is highly stable in an off-line evaluation for at least 10 weeks while the data in Table 6 shows that the dispersion is highly stable for at least 10 weeks in a simulated printer.

TABLE 5
Off-Line Evaluation of CG Dispersion Stability (Fresh v. 10 Week)

| | V@0.00 μJ | V@0.18 μJ | V@1.00 μJ | dV@0.1 s | dV@1.0 s |
|---|---|---|---|---|---|
| | 115 ms | 115 ms | 115 ms | decay | decay |
| Example 1 0-week dispersion | −747.8 | −177.1 | −60.7 | 3.5 | 30.9 |
| Example 1 0-week dispersion | −744.1 | −175.5 | −61.1 | 4.2 | 37.7 |
| Example 1 0-week Average | −745.9 | −176.3 | −60.9 | 3.9 | 34.3 |
| Example 1 10-week dispersion | −746.6 | −189.6 | −64.9 | 2.5 | 21.6 |
| Example 1 10-week dispersion | −746.4 | −188.2 | −64.6 | 3.2 | 28.1 |
| Example 1 10-week Average | −746.5 | −188.9 | −64.8 | 2.8 | 24.8 |

TABLE 6
TiOPC(IV) CuPC (Example 1) dispersion stability evaluation in printer
0 week vs. 10-week

| | | | | Discharge Voltage | | | | | |
|---|---|---|---|---|---|---|---|---|---|
| Formulation | Pages | TTP | TTC | SOT | 5K, H | 5K, C | 10K, H | 10K, C | Fatigue |
| Example 1, | 10,000 | 10.7 | 15.2 | 293 | 284 | 281 | 281 | 274 | 12 |
| fresh | | | | | | | | | |
| dispersion | | | | | | | | | |
| Example 1, | 10,000 | 8.6 | 18.0 | 292 | 284 | 280 | 280 | 274 | 12 |
| fresh | | | | | | | | | |
| dispersion | | | | | | | | | |
| Example 1, | 10,000 | 9.3 | 18.0 | 299 | 285 | 286 | 281 | 280 | 18 |
| 10-week | | | | | | | | | |
| dispersion | | | | | | | | | |
| Example 1, | 10,000 | 11.0 | 16.2 | 297 | 287 | 287 | 284 | 280 | 13 |
| 10-week | | | | | | | | | |
| dispersion | | | | | | | | | |

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention. It is intended that the scope of the invention be defined by the claims appended hereto.

What is claimed is:

1. A photoconductor, comprising:
an electrically conductive substrate;
a charge generation layer disposed over the electrically conductive substrate, wherein the charge generation layer comprises titanyl phthalocyanine and copper phthalocyanine; and
a charge transport layer disposed over the charge generation layer.

2. The photoconductor of claim 1 wherein the titanyl phthalocyanine comprises titanyl phthalocyanine (I), titanyl phthalocyanine (IV), or combinations thereof.

3. The photoconductor of claim 1 wherein the charge generation layer comprises a thickness of about 0.1 to about 1 μm.

4. The photoconductor of claim 1 wherein the charge generation layer comprises a mean particle size between about 100 to about 200 nm.

5. The photoconductor of claim 1 wherein the charge generation layer comprises a mean particle size preferably between 160 and 180 nm.

6. The photoconductor of claim 1 wherein the electrically conductive substrate is an anodized and sealed aluminum core.

7. The photoconductor of claim 1 wherein the copper phthalocyanine and titanyl phthalocyanine are dispersed in a binder.

8. The photoconductor of claim 7 wherein the ratio by weight of copper phthalocyanine and titanyl phthalocyanine to binder is about 3 to 2.

9. The photoconductor of claim 1 wherein the binder comprises polyvinyl butyral, epoxy resin, and combinations thereof.

10. The photoconductor of claim 1 wherein the ratio by weight of titanyl phthalocyanine to copper phthalocyanine is from about 50/50 to about 99/1.

11. The photoconductor of claim 1 wherein the charge transport layer comprises an aromatic amine and a polycarbonate in an organic solvent.

12. The photoconductor of claim 11 wherein the aromatic amine comprises N,N′-Bis(3-methylphenyl)-N,N′-diphenylbenzidine (TPD).

13. The photoconductor of claim 11 wherein the organic solvent comprises tetrahydrofuran, 1,4 dioxane, or mixtures thereof.

14. The photoconductor of claim 1 wherein the charge transport layer comprises a thickness of about 20 to about 30 μm.

15. A printer comprising the photoconductor of claim 1.

16. A method of preparing a photoconductor comprising:
providing an electrically conductive substrate;
dispersing titanyl phthalocyanine and copper phthalocyanine in a binder without first grinding the titanyl phthalocyanine;
milling the dispersed titanyl phthalocyanine and copper phthalocyanine inside the binder to produce a charge generation layer over the electrically conductive substrate; and,
coating the charge generation layer with a charge transport layer to form the photoconductor.

17. The method of claim 16 further comprising curing the charge transport layer at 110° C. for about 1 hour.

18. The method of claim 16 wherein the charge transport layer comprises an aromatic amine and a polycarbonate in an organic solvent.

19. The method of claim 16 wherein the ratio by weight of titanyl phthalocyanine to copper phthalocyanine is from about 50/50 to about 99/1.

20. The method of claim 16 wherein the titanyl phthalocyanine comprises titanyl phthalocyanine (I), titanyl phthalocyanine (IV), or combinations thereof.

21. The method of claim 20 wherein the ratio by weight of copper phthalocyanine and titanyl phthalocyanine to binder is about 3 to 2.
